(19) United States
(12) Patent Application Publication
(10) Pub. No.: US 2016/0025580 A1
(43) Pub. Date: Jan. 28, 2016

(54) PRESSURE SENSOR

(71) Applicant: DENSO CORPORATION, Kariya-city, Aichi (JP)

(72) Inventors: Kouji OOYA, Anjo-city (JP); Kazuhiko KANO, Toyoake-city (JP); Akihiko TESHIGAHARA, Nisshin-city (JP); Shinji KASHIWADA, Kariya-city (JP); Takayuki SHIBATA, Nisshin-city (JP); Inao TOYODA, Anjo-city (JP)

(21) Appl. No.: 14/770,207

(22) PCT Filed: Feb. 4, 2014
(86) PCT No.: PCT/JP2014/000579

§ 371 Date: Aug. 25, 2015

(30) Foreign Application Priority Data
Mar. 26, 2013 (JP) 2013-064489

(51) Int. Cl. G01L 9/00

(52) U.S. Cl. CPC G01L 9/0025

(57) ABSTRACT

An antenna unit having an antenna coil pattern is disposed in a casing. A sensor unit has a surface acoustic wave detecting element including a first sensing electrode that generates and receives a surface acoustic wave and a first reflector that reflects the surface acoustic wave, which are provided on a substrate configured of a piezoelectric material, and a sensor coil pattern electrically connected to the first sensing electrode and coupled to the antenna coil pattern. The sensor unit is disposed in a pressure receiving portion, and a signal is transmitted between the sensor unit and the antenna unit by wireless communication resulting from a coil coupling.

### CROSS REFERENCE TO RELATED APPLICATION

This application is based on Japanese Patent Application No. 2013-64489 filed on Mar. 26, 2013, the disclosure of which is incorporated herein by reference.

### TECHNICAL FIELD

The present disclosure relates to a pressure sensor.

### BACKGROUND ART

Patent Literature 1 proposes a pressure sensor having a sensor portion that outputs a sensor signal in accordance with a pressure.

Specifically, a pressure sensor includes a bottomed tubular case having a hollow portion. A diaphragm is provided in an aperture portion of the case, and a sensor unit that outputs a sensor signal in accordance with pressure is provided on the bottom portion opposite through the hollow portion. A pressure transmitting member in contact with the diaphragm and the bottom portion is disposed inside the hollow portion of the case. In order to accurately transmit pressure applied to the diaphragm to the sensor unit, the pressure transmitting member is disposed in a state where a preload is applied to the sensor unit.

The case is provided on one end of a tubular housing having a hollow portion, and the sensor unit is electrically connected via a wiring member such as a flexible substrate to a circuit substrate, or the like, disposed inside the housing. The sensor unit and the wiring member are connected via solder.

The sensor unit is disposed to distance from the diaphragm in this kind of pressure sensor, so the temperature of the sensor unit can be lower than that of the diaphragm. Because of this, even when the diaphragm has a high temperature, the connection portion (solder) between the sensor unit and the wiring substrate can be prevented from reaching a high temperature, whereby reliability of the connection portion can be secured.

### PRIOR ART LITERATURES

### Patent Literature

Patent Literature 1: JP 2008-76155 A

### SUMMARY OF INVENTION

However, the pressure sensor of Patent Literature 1 has a possibility of the diaphragm being destroyed if the preload of the pressure transmitting member is too large, and the pressure transmission is unstable if the preload is too small. Because the preload of the pressure transmitting member has to be strictly managed (regulated), the structure of the pressure sensor becomes complex.

The present disclosure has an object of providing a pressure sensor with a simplified structure under high-temperature environment.

According to an aspect of the present disclosure, a pressure sensor includes: a casing having a tubular shape with a hollow portion and having conductivity; a pressure receiving portion having conductivity and provided in the casing to be capable of distorting by receiving a pressure of a measurement medium; and a sensor unit provided in the casing by being disposed in the pressure receiving portion to output a sensor signal in accordance with the measurement medium.

An antenna unit is disposed in the casing and has an antenna coil pattern. The sensor unit has a surface acoustic wave detecting element including a first sensing electrode that generates and receives a surface acoustic wave and a first reflector that reflects the surface acoustic wave, which are provided on a substrate configured of a piezoelectric material, and a sensor coil pattern electrically connected to the first sensing electrode and having a coil coupling with the antenna coil pattern. When the sensor unit receives a drive signal from the antenna unit by wireless communication resulting from the coil coupling, the sensor unit emits the surface acoustic wave from the first sensing electrode and receives the surface acoustic wave reflected by the first reflector, and transmits the sensor signal based on the received surface acoustic wave to the antenna unit by wireless communication resulting from the coil coupling.

According to this, as wireless communication resulting from the coil coupling is carried out between the sensor unit and the antenna unit, there is no need to dispose a connection member such as solder in the sensor unit, because of which the sensor unit is disposed directly on the pressure receiving portion. Therefore, there is no need to dispose a pressure transmitting member between the sensor unit and the pressure receiving portion, and no need either to strictly manage a pressure transmitting member. Thus, the structure can be simplified.

Also, as the sensor unit and the antenna unit are surrounded by the casing and the pressure receiving portion having conductivity, external noise can be prevented from permeating from the exterior by an electrostatic shielding effect, and the drive signal and sensor signal can be prevented from leaking to the exterior.

### BRIEF DESCRIPTION OF DRAWINGS

FIG. 1 is a schematic sectional view of a pressure sensor according to a first embodiment.

FIG. 2 is an enlarged view of a region II in FIG. 1.

FIG. 3 is a front surface view illustrating a sensor unit of the pressure sensor.

FIG. 4 is a front surface view illustrating an antenna unit of the pressure sensor.

FIG. 5 is a schematic view showing a state of communication between the sensor unit and the antenna unit.

FIG. 6 is a schematic sectional view of a pressure sensor according to a second embodiment.

FIG. 7 is a schematic sectional view of a pressure sensor according to a third embodiment.

FIG. 8 (a) is a front surface view of a first ceramic substrate, FIG. 8 (b) is a front surface view of a second ceramic substrate, and FIG. 8 (c) is a back surface view of the second ceramic substrate.

FIG. 9 is a sectional view illustrating a sensor unit of a pressure sensor according to a fourth embodiment.

FIG. 10 (a) is a top view of a first substrate, and FIG. 10 (b) is a top view of a second substrate.

FIG. 11 is a top view illustrating a sensor unit of a pressure sensor according to a fifth embodiment.

FIG. 12 is a top view illustrating modifications of the sensor unit of the pressure sensor in the fifth embodiment.

FIG. 13 is a schematic sectional view of a pressure sensor according to a sixth embodiment.

FIG. 14 is a schematic sectional view of a pressure sensor according to a seventh embodiment.

### DESCRIPTION OF EMBODIMENTS

Embodiments of the disclosure will be described based on the drawings. In each of the following embodiments, a description is given with the same reference signs given to portions that are the same as or equivalent to each other.

### First Embodiment

A first embodiment will be described with reference to the drawings. A pressure sensor of this embodiment is to be installed in, for example, an engine of an automobile, and is utilized for detecting pressure in a combustion chamber of the engine.

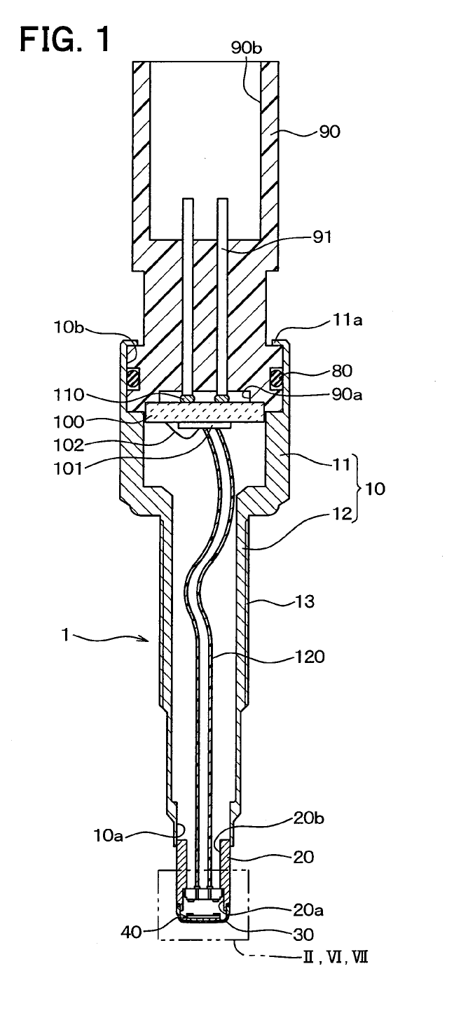

As shown in FIG. 1, a pressure sensor includes a cylindrical housing 10 having a hollow portion, and the two ends of the hollow portion are defined by aperture portions 10a, 10b respectively. The housing 10 of this embodiment has a cylindrical main body portion 11, and an elongated cylindrical pipe portion 12. The inner diameter and the outer diameter of the pipe portion 12 are smaller than those of the main body portion 11. A screw portion 13 that can be joined by screwing to an installation target member is provided on the outer peripheral wall surface of the pipe portion 12. This kind of housing 10 is configured by, for example, a metal such as SUS 630 and is integrally formed by cutting, cold forging, or the like.

Further, a metal case 20 is provided in a distal end portion (the aperture portion 10a of the housing 10) of the pipe portion 12. Specifically, the metal case 20 is shaped in a cylinder having a hollow portion, and the two ends of the hollow portion are aperture portions 20a and 20b. The end portion of the metal case adjacent to the aperture portion 20b is joined by laser welding or the like to the distal end portion of the pipe portion 12 such that the hollow portion of the metal case 20 communicates with the hollow portion of the pipe portion 12.

In this embodiment, a casing 1 is configured of the housing 10 and the metal case 20.

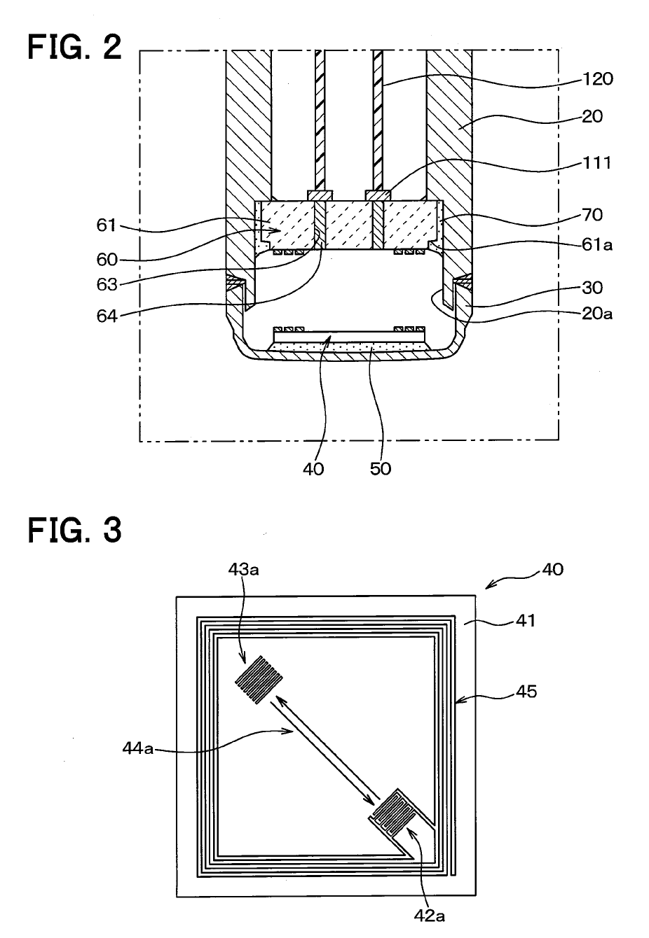

As shown in FIG. 1 and FIG. 2, a metal diaphragm 30 that can be distorted by the pressure of a measurement medium is provided in the end portion of the metal case 20 adjacent to the aperture portion 20a. The metal diaphragm 30 has a tube form with a bottom portion, and the bottom portion is a diaphragm portion that distorts in accordance with pressure. The end portion of the diaphragm adjacent to the aperture portion is joined by laser welding or the like to the end portion of the metal case 20 adjacent to the aperture portion 20a.

In this embodiment, the metal diaphragm 30 corresponds to a pressure receiving portion. The metal case 20 and the metal diaphragm 30 are configured by, for example, a metal such as SUS 630 being cut, cold forged, or the like.

The back surface of a sensor unit 40, which outputs a sensor signal in accordance with pressure, is provided to the metal diaphragm 30 through a joining member 50 such as glass. Hereafter, the configuration of the sensor unit 40 of this embodiment will be specifically described with reference to FIG. 3. The back surface of the sensor unit 40 is a surface of the sensor unit 40 opposing the metal diaphragm 30. A front surface of the sensor unit 40, to be described hereafter, is a surface of the sensor unit 40 opposite from the back surface.

As shown in FIG. 3, the sensor unit 40 is a surface acoustic wave detecting element configured using a rectangular plate form substrate 41 made of a piezoelectric material. Specifically, a sensing electrode 42a that generates (excites) and receives a surface acoustic wave (SAW), and a reflector 43a disposed to separate from the sensing electrode 42a and to reflect a surface acoustic wave emitted from the sensing electrode 42a, are provided on the surface of the substrate 41. Further, a portion (path) between the sensing electrode 42a and the reflector 43a is a propagation path 44a along which a surface acoustic wave is propagated.

The sensing electrode 42a and the reflector 43a are configured of interdigital transducers (IDT) in which conductor patterns of differing polarities are alternately aligned at constant intervals. The interval between conductor patterns is appropriately set so as to obtain a wavelength of a predetermined resonance frequency. In this embodiment, the sensing electrode 42a corresponds to a first sensing electrode, and the reflector 43a corresponds to a first reflector.

A coil pattern 45 (sensor coil pattern) is provided on the substrate 41 so as to short-circuit the interdigital transducer configuring the sensing electrode 42a. The coil pattern 45 is configured by a conductor pattern extended spirally along the outer edge of the substrate 41 in such a way that the sensing electrode 42a and the reflector 43a are disposed in a region on the inner side of the coil pattern 45. The sensing electrode 42a and the reflector 43a are respectively disposed at corner portions diagonally opposing to each other in the rectangular region on the inner side of the coil pattern 45.

As shown in FIG. 2, an antenna unit 60 is provided to the metal case 20 through a joining member 70 made of glass or the like to oppose the sensor unit 40, and is capable of wireless communication with the sensor unit 40.

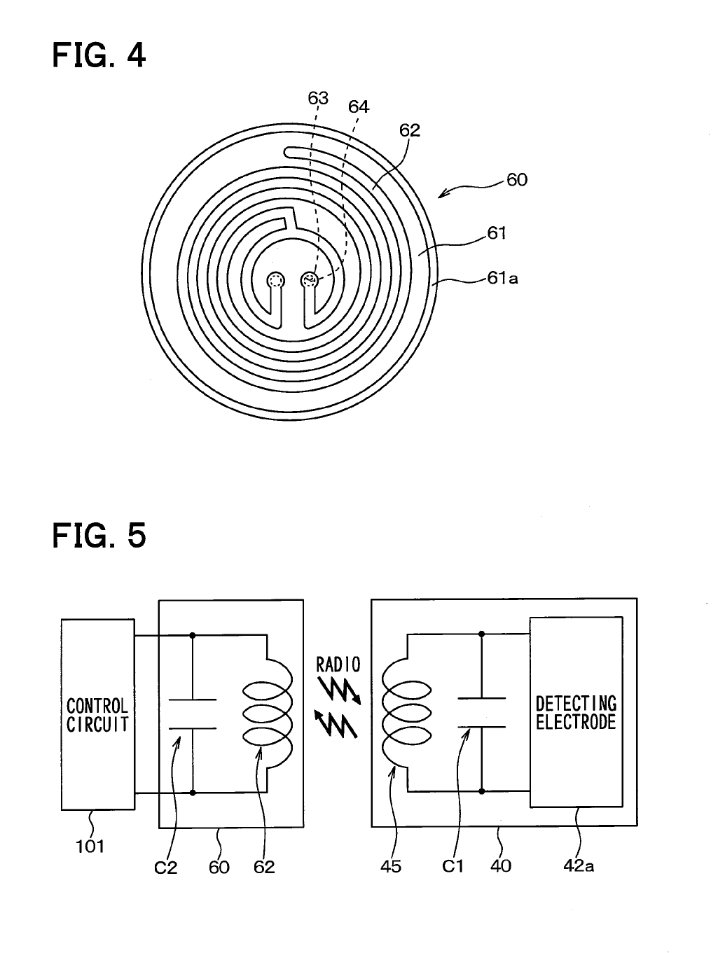

Specifically, as shown in FIG. 2 and FIG. 4, the antenna unit 60 is configured using a disc-shaped ceramic substrate 61. An outer edge portion of the ceramic substrate 61 on the side surface and the back surface is attached to the metal case 20 across the joining member 70. That is, a space between the antenna unit 60 and the sensor unit 40 is a sealed space.

A front surface of the ceramic substrate 61, to be described hereafter, is a surface opposing the sensor unit 40, and the back surface of the ceramic substrate 61 is a surface of the ceramic substrate 61 opposite from the front surface opposing the sensor unit 40.

A coil pattern 62 (antenna coil pattern) to be coupled to the coil pattern 45 is provided on the front surface of the ceramic substrate 61, and is spirally extended along the outer edge of the ceramic substrate 61. The antenna unit 60 and the sensor unit 40 are capable of wireless communication via the coil patterns 45 and 62. In other words, the antenna unit 60 is disposed in the metal case 20 in such a way that the coil pattern 45 and the coil pattern 62 are coupled with each other.

The ceramic substrate 61 has a through hole 63 passing through in the thickness direction at an approximately central portion. An electrode 64 is fitted in the through hole 63, and is electrically connected to the coil pattern 62 exposed from the back surface of the ceramic substrate 61.

The ceramic substrate 61 of this embodiment has a recess portion 61a along an outer peripheral portion in the front surface, whereby the outer peripheral portion is in a recessed state. Therefore, the joining member 70 disposed on the side surface of the ceramic substrate 61 can be prevented from creeping up onto the front surface of the ceramic substrate 61 and from adhering to the coil pattern 62.

As shown in FIG. 1, a connector member 90 is mounted in the aperture portion 10b of the housing 10 through an O-ring 80. The connector member 90 is an approximately columnar portion configured of resin material such as polyphenylene sulfide (PPS). The connector member 90 has a recess portion 90a provided in one end portion, and an aperture portion 90b provided in the other end portion.

The one end portion of the connector member 90 is inserted into the aperture portion 10b of the housing 10, and an aperture end portion 11a of the housing 10 adjacent to the aperture portion 10b is plastically deformed. Thus, the connector member 90 and the housing 10 are made into one-piece component.

Multiple terminals 91 are provided in the connector member 90. Each terminal 91 is held inside the connector member 90 by being integrally formed with the connector member 90 by insert molding.

Specifically, the terminal 91 is held by passing through the connector member 90. One end portion of the terminal 91 protrudes into the recess portion 90a, and the other end portion of the terminal 91 protrudes into the aperture portion 90b.

A wiring substrate 100 made of a ceramic substrate or the like is provided to the one end portion of the connector member 90 to close the recess portion 90a. Wiring patterns (not shown) are provided on the front and back surfaces of the wiring substrate 100, and the wiring patterns provided on the front and back surfaces are electrically connected via an electrode (not shown) embedded in a through hole. A control circuit 101 is mounted on the front surface (the surface adjacent to the antenna unit 60) of the wiring substrate 100, and generates a drive signal that drives the sensing electrode 42a and regulates a sensor signal. The control circuit 101 is electrically connected to the wiring pattern provided on the front surface of the wiring substrate 100 via a bonding wire 102.

The one end portion of the terminal 91 exposed from the recess portion 90a is electrically connected to the wiring pattern provided on the back surface of the wiring substrate 100 via a solder 110. The other end portion of the terminal 91 exposed from the aperture portion 90b is connected to a non-illustrated external wiring member or the like.

A wiring member 120 is disposed inside the housing 10, and the antenna unit 60 and the control circuit 101 are electrically connected to each other via the wiring member 120. Specifically, one end portion of the wiring member 120 is electrically connected to the electrode 64 exposed from the back surface of the antenna unit 60 via solder 111 (refer to FIG. 2). The other end portion of the wiring member 120 is electrically connected to a pad or the like provided on the control circuit 101 via solder (not shown).

A lead wire, a flexible printed circuit (FPC), or the like, is used as the wiring member 120.

Next, an operation of the pressure sensor will be described.

As shown in FIG. 5, in the pressure sensor, the coil pattern 62 provided on the antenna unit 60 and the coil pattern 45 provided in the sensor unit 40 are capable of wireless communication owing to electromagnetic induction due to the coil coupling. A capacitor C1 in FIG. 5 is a capacitance component configured between the conductor patterns configuring the coil pattern 45, while a capacitor C2 is a capacitance component configured between the conductor patterns configuring the coil pattern 62.

Firstly, when a drive signal of a predetermined frequency is applied from the control circuit 101 to the coil pattern 62 (antenna unit 60) such that the resonance frequency of the sensing electrode 42a is applied to the sensing electrode 42a, the drive signal is applied via the coil pattern 45 to the sensing electrode 42a. Then, a surface acoustic wave is generated by the sensing electrode 42a owing to a piezoelectric effect, and the surface acoustic wave is transmitted along the propagation path 44a and is reflected by the reflector 43a. Subsequently, the reflected surface acoustic wave passes along the propagation path 44a again, is received (detected) by the sensing electrode 42a, and converted into a sensor signal, which is a frequency signal, by the sensing electrode 42a using the piezoelectric effect. At this time, when pressure is applied to the metal diaphragm 30, the phase of the surface acoustic wave changes in accordance with the pressure while the surface acoustic wave is propagated along the propagation path 44a. Because of this, the sensor signal is a signal in accordance with the pressure.

Subsequently, the sensor signal is transmitted to the control circuit 101 via the coil patterns 45 and 62, the wiring member 120, and the like, and the control circuit 101 detects the pressure applied to the metal diaphragm 30 by calculating the phase difference between the drive signal and the sensor signal.

According to the present embodiment, wireless communication resulting from the coil coupling is carried out between the sensor unit 40 and the antenna unit 60. Therefore, as there is no need to dispose a connection member such as solder in the sensor unit 40, the sensor unit 40 is disposed directly on the metal diaphragm 30. Because of this, there is no need to dispose a pressure transmitting member between the sensor unit and the metal diaphragm 30, and no need either to strictly manage a pressure transmitting member. Thus, the structure can be simplified.

Also, as the sensor unit 40 and the antenna unit 60 are surrounded by the metal case 20 and the metal diaphragm 30, external noise can be prevented from permeating from the exterior by an electrostatic shielding effect, and the drive signal and sensor signal can be prevented from leaking to the exterior.

Furthermore, as the sensor unit 40 has a surface acoustic wave detecting element, it is sufficient that one coil pattern 45 is provided on the sensor unit 40 and that one coil pattern 62 is provided on the antenna unit 62. Thus, the signal transmission is not complex.

### Second Embodiment

A second embodiment will be described. In the present embodiment, the configuration of a pressure receiving portion is changed with respect to that of the first embodiment, but is the same as the first embodiment with regard to other aspects, because of which a description of those aspects is omitted.

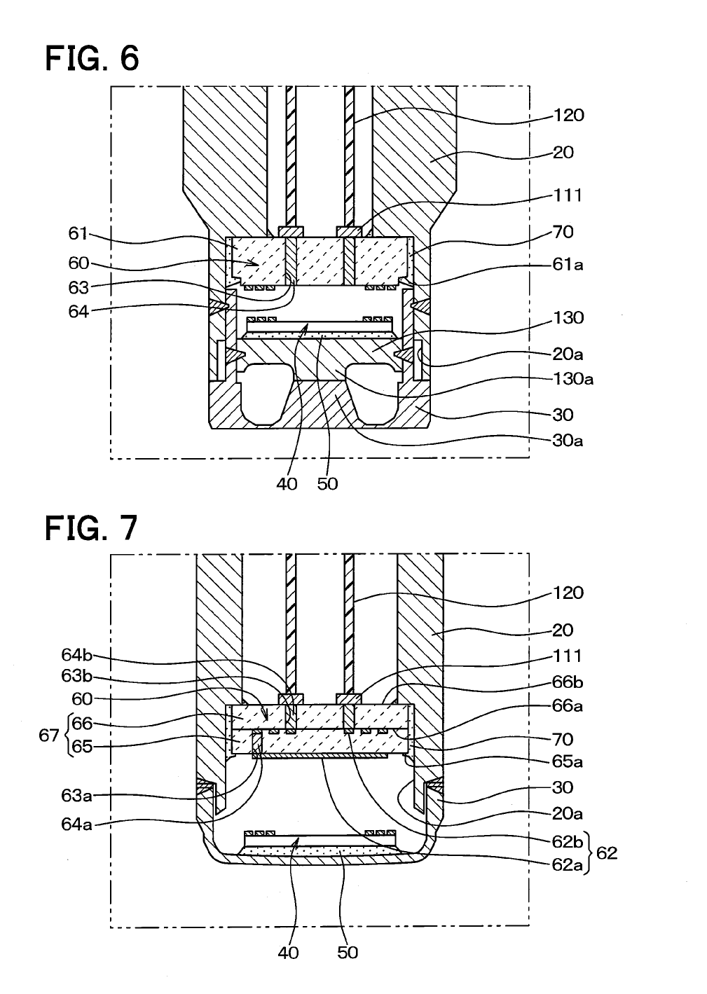

As shown in FIG. 6, in this embodiment, a load transmitting member 130 is disposed between the metal diaphragm 30 and the sensor unit 40, and transmits a predetermined ratio of pressure applied to the metal diaphragm 30 to the sensor unit 40. In this embodiment, the metal diaphragm 30 and the load transmitting member 130 configure a pressure receiving portion. Also, FIG. 6 corresponds to an enlarged view of a region VI in FIG. 1.

The load transmitting member 130 is of a disc form, and has a protruding portion 130a protruding toward the metal diaphragm 30 at an approximately central portion. This kind of load transmitting member 130 is configured by, for example, a metal such as SUS 630 being integrally formed by cutting, cold forging, or the like. The metal diaphragm 30 has a protruding portion 30a protruding toward the housing 10 at an approximately central portion.

A side surface of the load transmitting member 130 is joined to a side surface of the metal diaphragm 30 by laser welding or the like such that the protruding portion 130a is in contact with the protruding portion 30a of the metal diaphragm 30.

The sensor unit 40 is provided on a surface of the load transmitting member 130 opposite from the protruding portion 130a through a joining member 50.

Because pressure applied to the metal diaphragm 30 is transmitted via the load transmitting member 130 to the sensor unit 40, a predetermined ratio of the pressure applied to the metal diaphragm 30 is applied to the sensor unit 40. Therefore, even when a foreign material such as soot accumulates on a portion of the metal diaphragm 30 exposed to a measurement medium, the detection sensitivity can be restricted from decreasing.

For example, a case will be described in which the load transmitting member 130 transmits 70% of the pressure applied to the metal diaphragm 30 to the sensor unit 40. In this case, when no foreign material is accumulated on the metal diaphragm 30, 70% of the pressure applied to the metal diaphragm 30 is applied to the sensor unit 40. When a foreign material is accumulated on the metal diaphragm 30, provided that the pressure applied to the metal diaphragm 30 decreases by 30% due to the foreign material, the pressure applied to the sensor unit 40 decreases by 30%, if the load transmitting member 130 is not disposed.

According to the embodiment in which the load transmitting member 130 is provided, as 70% of the pressure applied to the metal diaphragm 30 is transmitted to the sensor unit 40, 49% of the pressure that should normally be applied is applied to the sensor unit 40. That is, even when a foreign material is accumulated on the metal diaphragm 30, the pressure applied to the sensor unit 40 decreases by 21% with respect to the pressure transmitted to the sensor unit 40 before the foreign material is accumulated. Thus, the decreasing ratio in the detection sensitivity can be reduced.

While the load transmitting member 130 is in contact with the metal diaphragm 30 and the sensor unit 40, strict management for applying a highly accurate preload to the sensor unit 40 is not necessary.

### Third Embodiment

A third embodiment will be described. In the present embodiment, the configuration of the antenna unit 60 is changed with respect to that of the first embodiment, but is the same as the first embodiment with regard to other aspects, because of which a description of those aspects is omitted.

As shown in FIG. 7, in this embodiment, the antenna unit 60 is configured using a multilayer substrate 67 in which a first ceramic substrate 65 and a second ceramic substrate 66 are stacked. A surface of the first ceramic substrate 65 opposing the sensor unit 40 is defined as a front surface 65a. A surface of the second ceramic substrate 66 joined to the first ceramic substrate 65 is defined as a front surface 66a, and a surface of the second ceramic substrate 66 opposite from the front surface 66a is defined as a back surface 66b. FIG. 7 corresponds to an enlarged view of a region VII in FIG. 1.

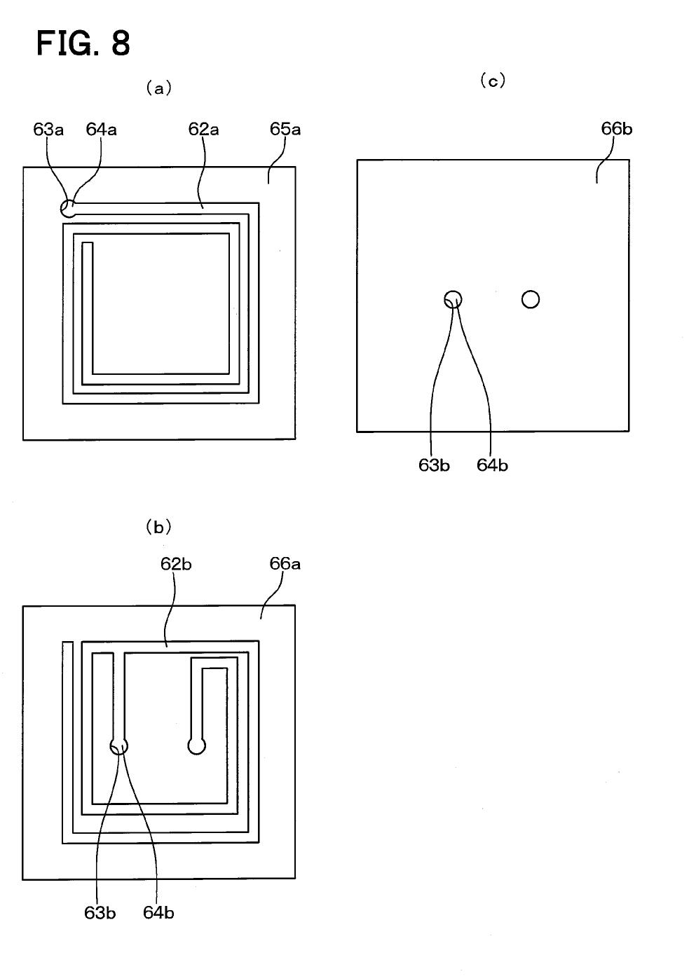

As shown in FIG. 7 and FIG. 8, a first coil pattern 62a is provided on the front surface 65a of the first ceramic substrate 65, and a first electrode 64a electrically connected to the first coil pattern 62a is disposed in a first through hole 63a penetrating in the thickness direction. A second coil pattern 62b is provided on the front surface of the second ceramic substrate 66 and is electrically connected to the first electrode 64a. A second electrode 64b is disposed in a second through hole 63b penetrating in the thickness direction, and is electrically connected to the second coil pattern 62b. The coil pattern 62 is provided by a coupling of the first and second coil patterns 62a and 62b.

According to this, the first and second coil patterns 62a and 62b are provided on the first and second ceramic substrates 65 and 66, respectively. The coil pattern 62 is formed of the first and second coil patterns 62a and 62b. Therefore, the number of turns (length) of the coil pattern 62 can be increased. Because of this, the coupling strength of the coil pattern 45 and the coil pattern 62 can be increased, whereby communication loss can be reduced.

The multilayer substrate 67 is configured by the first and second ceramic substrates 65 and 66 being stacked, but the antenna unit 60 may be configured using the multilayer substrate 67 in which multiple of ceramic substrates are further stacked.

### Fourth Embodiment

A fourth embodiment will be described. In the present embodiment, the configuration of the sensor unit 40 is changed with respect to that of the first embodiment, but is the same as the first embodiment with regard to other aspects, because of which a description of those aspects is omitted.

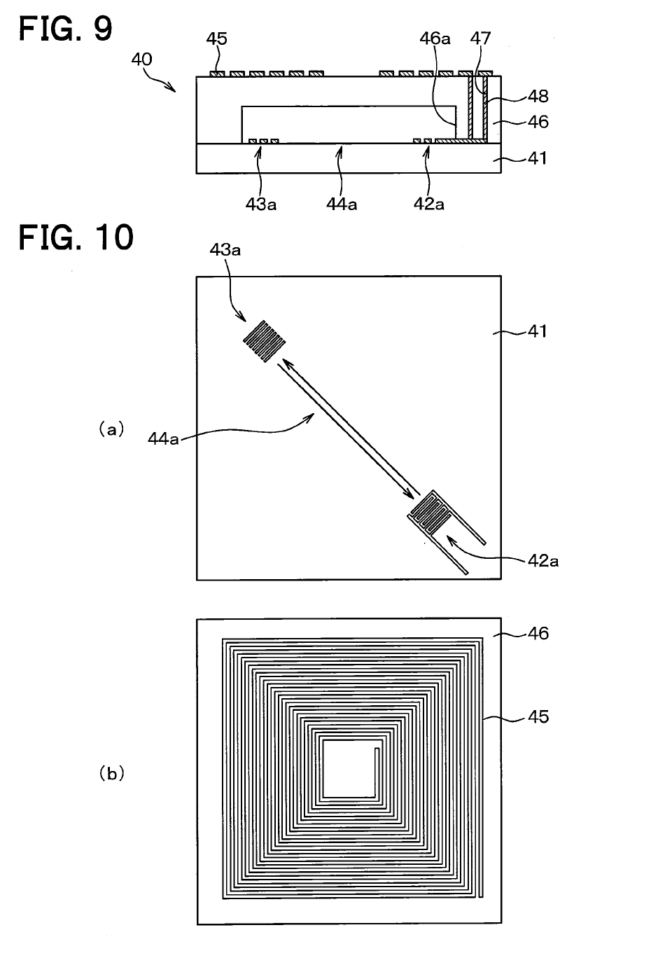

As shown in FIG. 9 and FIG. 10, the sensor unit 40 of this embodiment has a substrate 46 made of silicon or the like, and the substrate 46 is joined to the substrate 41. A recess portion 46a is provided in the surface of the substrate 46 opposing the substrate 41, whereby a sealed space is configured between the substrate 41 and the recess portion 46a. In this embodiment, the substrate 41 corresponds to a first substrate, and the substrate 46 corresponds to a second substrate.

The sensing electrode 42a and the reflector 43a are provided on the substrate 41 in the portion sealed by the recess portion 46a. That is, it can be said that the substrate 46 has the recess portion 46a at a position opposing the sensing electrode 42a and the reflector 43a. It can also be said that the substrate 46 works as a cap that seals the sensing electrode 42a and the reflector 43a.

The substrate 46 has the coil pattern 45 on the surface opposite from the substrate 41, and a through hole 47 penetrating in the thickness direction. An electrode 48 is embedded in the through hole 47, and is electrically connected to the coil pattern 45 and the sensing electrode 42a. Two of the electrode 48 are disposed in the substrate 46, and connect the sensing electrode 42a and the coil pattern 45 so as to short-circuit the interdigital transducer configuring the sensing electrode 42a. FIG. 9 is a schematic sectional view of FIG. 10, and the coil pattern 45 and the like are illustrated in the simplified state in FIG. 9.

According to this, as the sensing electrode 42a, the reflector 43a, and the propagation path 44a are sealed, the resistance to the environment can be increased. The coil pattern 45 is provided on the substrate 46, which is different from the substrate 41 on which the sensing electrode 42a and the reflector 43a are provided. Therefore, the number of turns (length) of the coil pattern 45 can be increased. Because of this, the coupling strength of the coil pattern 45 and the coil pattern 62 can be increased, whereby communication loss can be reduced.

### Fifth Embodiment

A fifth embodiment will be described. In the present embodiment, the configuration of the sensor unit 40 is changed with respect to that of the first embodiment, but is the same as the first embodiment with regard to other aspects, because of which a description of those aspects is omitted.

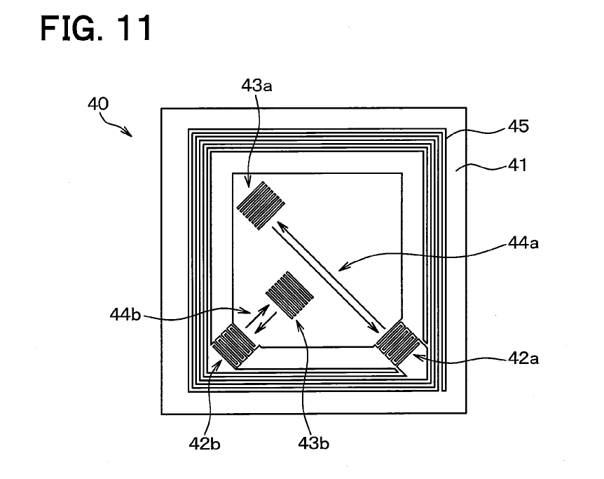

As shown in FIG. 11, in this embodiment, a first sensing electrode 42a, a second sensing electrode 42b, a first reflectors 43a and a second reflector 43b are provided on the front surface of the substrate 41, such that a length of a first propagation path 44a between the first sensing electrodes 42a and the first reflector 43a is different from a length of a second propagation path 44b between the second sensing electrode 42b and the second reflector 43b.

In this embodiment, the first sensing electrode 42a is provided at one corner portion in a rectangular region on the inner side of a coil pattern 45, and the first reflector 43a is provided at the other corner portion diagonally opposing to the one corner portion. A region between the first sensing electrode 42a and the first reflector 43a is the first propagation path 44a.

The second sensing electrode 42b and the second reflector 43b are provided in the rectangular region on the inner side of the coil pattern 45. The second propagation path between the second sensing electrode 42b and the second reflector 43b does not intersect the first propagation path 44a, and the propagation direction of the second propagation path is perpendicular to the propagation direction of the first propagation path 44a. To describe in detail, the second sensing electrode 42b is provided at a corner portion different from the corner portions in which the first sensing electrode 42a and the first reflector 43a are provided in the rectangular region on the inner side of the coil pattern 45. The second reflector 43b is provided at an approximately central portion of the rectangular region on the inner side of the coil pattern 45, and is located between the second sensing electrode 42b and the first propagation path 44a.

The first and second sensing electrodes 42a and 42b and the first and second reflectors 43a and 43b have the same form as each other. The propagation direction is a direction in which a surface acoustic wave is propagated along the first or second propagation path 44a, 44b.

Further, the coil pattern 45 is provided so as to short-circuit each of the first and second sensing electrodes 42a and 42b.

According to this, even when warping occurs in the substrate 41 due to temperature variation, the affecting caused by the temperature variation can be reduced. That is, when warping occurs in the substrate 41, a surface acoustic wave is affected by the warping in accordance with the length of the propagation path. The control circuit 101 calculates a sensor signal based on a surface acoustic wave emitted from the first sensing electrode 42a and calculates a sensor signal based on a surface acoustic wave emitted from the second sensing electrode 42b, and detects the pressure by cancelling the affecting caused by the temperature variation.

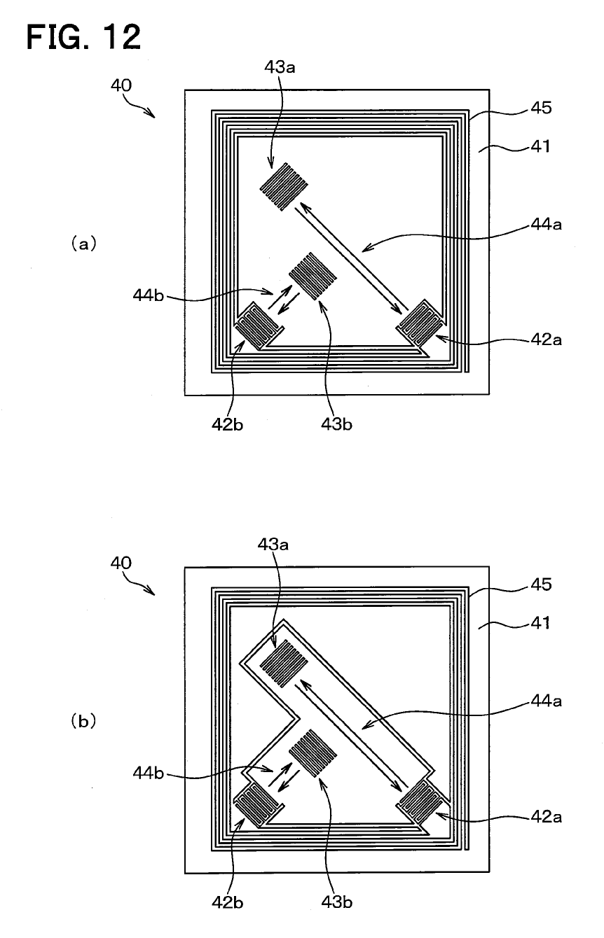

As shown in FIG. 12, the form of the coil pattern 45 electrically connected to the first and second sensing electrodes 42a and 42b can be changed as appropriate. Also, the locations of the first and second sensing electrodes 42a and 42b and the first and second reflectors 43a and 43b may be changed as appropriate while the length of the first propagation path 44a is different from that of the second propagation path 44b. That is, the first propagation path 44a and the second propagation path 44b may be parallel in the propagation direction of the surface acoustic wave.

### Sixth Embodiment

A sixth embodiment will be described. In the present embodiment, the antenna unit 60 is embedded in the control circuit 101, but this embodiment is the same as the first embodiment with regard to other aspects, because of which a description of those aspects is omitted.

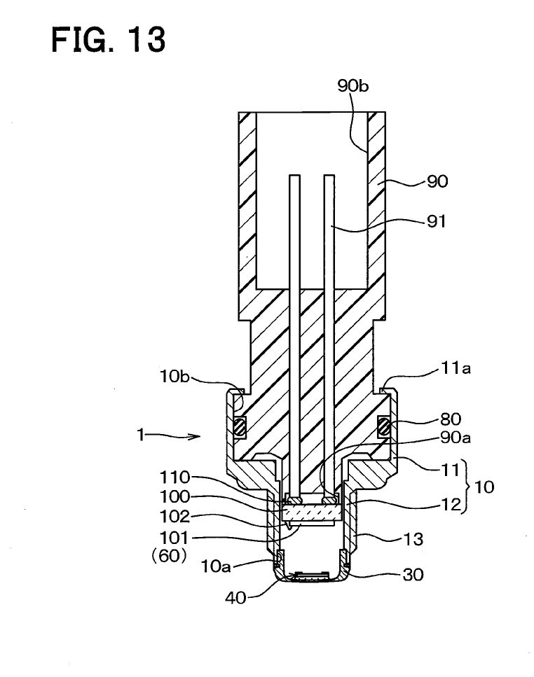

As shown in FIG. 13, in this embodiment, the metal diaphragm 30 is joined by laser welding or the like to a distal end portion (the aperture portion 10a of the housing 10) of the pipe portion 12. That is, in this embodiment, the housing 10 corresponds to the casing 1.

Further, the antenna unit 60 is integrated into the control circuit 101. That is, the coil pattern 62 is provided in the control circuit 101.

When the present disclosure is applied to this kind of pressure sensor, wireless communication can be obtained by a coil coupling between the coil pattern 62 provided in the control circuit 101 (antenna unit 60) and the coil pattern 45 provided in the sensor unit 40, Therefore, the same advantages as in the first embodiment can be obtained. This kind of pressure sensor is preferably used under a condition where the temperature of the metal diaphragm 30 does not become high. For example, this kind of pressure sensor is preferably installed in an air conditioning system, and may be utilized for detecting the pressure of refrigerant or the like.

### Seventh Embodiment

A seventh embodiment will be described. In this embodiment, compared with the sixth embodiment, a metal stem is provided in the housing 10, but this embodiment is the same as the first embodiment with regard to other aspects, because of which a description of those aspects is omitted.

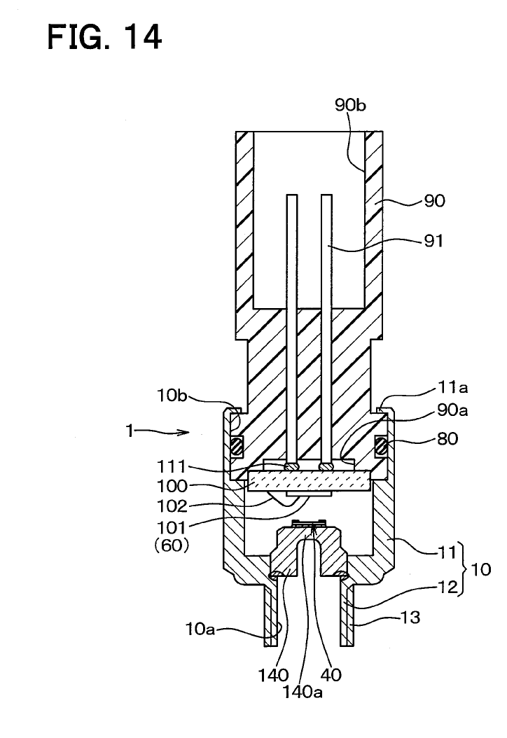

In this embodiment, a metal stem 140 is disposed in the housing 10, as shown in FIG. 14. Specifically, the metal stem 140 is of a bottomed tube form having a bottom portion, and a metal diaphragm 140a is configured in the bottom portion. Further, one end portion of the metal stem 140 adjacent to the aperture portion is joined by laser welding or the like to a boundary portion between the main body portion 11 and the pipe portion 12 in the housing 10.

In this embodiment, the metal diaphragm 140a in the metal stem 140 corresponds to a pressure receiving portion.

When the present disclosure is applied to this kind of pressure sensor, wireless communication can be obtained by a coil coupling between the coil pattern 62 provided in the control circuit 101 (antenna unit 60) and the coil pattern 45 provided in the sensor unit 40. Therefore, the same advantages as in the sixth embodiment can be obtained. As the sensor unit 40 is disposed inside the housing 10 (casing 1), heat radiation design can be facilitated, and furthermore, the pressure sensor can suitably detect pressure under a high-temperature environment.

For example, this kind of pressure sensor is preferably installed in the exhaust system of an engine as an installation target member, and may be utilized for detecting pressure upstream of a DPF (diesel particulate filter) or the like.

### Other Embodiments

It should be appreciated that the present disclosure is not limited to the embodiments described above and can be modified appropriately within the scope of the appended claims.

For example, while the wiring substrate 100 and the control circuit 101 are provided inside the housing 10, the wiring substrate 100 and the control circuit 101 may be provided outside the housing 10.

The embodiments can be combined as appropriate. For example, the second embodiment may be combined with the third to seventh embodiments, whereby a pressure receiving portion is configured of the metal diaphragm 30 and the load transmitting member 130. Also, the third embodiment may be combined with the fourth to seventh embodiments, whereby the antenna unit 60 is configured of the multilayer substrate 67. Furthermore, the fourth embodiment may be combined with the fifth to seventh embodiments, whereby the sensor unit 40 is configured of the first and second substrates 41 and 46. When the fourth embodiment is combined with the fifth embodiment, the recess portion 46a is provided in the substrate 46 at a position opposing the first and second sensing electrodes 42a and 42b and the first and second reflectors 43a and 43b. Also, the fifth embodiment may be combined with the sixth and seventh embodiments, whereby the first and second sensing electrodes 42a and 42b and the first and second reflectors 43a and 43b are provided in the sensor unit 40. Furthermore, combinations of the embodiments may be further combined as appropriate.

1. A pressure sensor comprising:
a casing having a tubular shape with a hollow portion and having conductivity;
a pressure receiving portion having conductivity and provided in the casing, the pressure receiving portion being capable of distorting by receiving a pressure of a measurement medium;
a sensor unit provided in the casing by being disposed in the pressure receiving portion, the sensor unit outputting a sensor signal in accordance with the measurement medium; and
an antenna unit disposed in the casing and having an antenna coil pattern, wherein
the sensor unit has
a surface acoustic wave detecting element including a first sensing electrode that generates and receives a surface acoustic wave and a first reflector that reflects the surface acoustic wave, which are provided on a substrate configured of a piezoelectric material, and
a sensor coil pattern electrically connected to the first sensing electrode and having a coil coupling with the antenna coil pattern, and
when the sensor unit receives a drive signal from the antenna unit by wireless communication resulting from the coil coupling, the sensor unit emits the surface acoustic wave from the first sensing electrode and receives the surface acoustic wave reflected by the first reflector, and transmits the sensor signal based on the received surface acoustic wave to the antenna unit by wireless communication resulting from the coil coupling.

2. The pressure sensor according to claim 1, wherein
the pressure receiving portion has
a metal diaphragm that directly receives the pressure of the measurement medium, and
a load transmitting member disposed between the sensor unit and the metal diaphragm to transmit a load having a predetermined ratio of pressure applied to the metal diaphragm to the sensor unit.

3. The pressure sensor according to claim 1, wherein
the antenna unit is configured of a multilayer substrate, and the antenna coil pattern is provided by a coupling of coil patterns provided in each layer.

4. The pressure sensor according to claim 1, wherein
the sensor unit further has a second substrate stacked on a first substrate corresponding to the substrate,
the second substrate has a recess portion opposing the first sensing electrode and the first reflector, and the sensor coil pattern is provided on a surface of the second substrate opposite from the first substrate, and
the first sensing electrode and the sensor coil pattern are electrically connected with each other via an electrode disposed in a through hole passing through the second substrate in a thickness direction.

5. The pressure sensor according to claim 1, wherein
the sensor unit further has a second sensing electrode that generates and receives a surface acoustic wave and a second reflector that reflects the surface acoustic wave, which are provided on the substrate in addition to the first sensing electrode and the first reflector, and
a first propagation path along which the surface acoustic wave emitted from the first sensing electrode is propagated and a second propagation path along which the surface acoustic wave emitted from the second sensing electrode is propagated are configured at different places, and a length of the first propagation path is different from a length of the second propagation path in a direction in which the surface acoustic wave is propagated.
